(19) United States
(12) Patent Application Publication
(10) Pub. No.: US 2019/0137679 A1
(43) Pub. Date: May 9, 2019

(54) LAMINATED LIGHTING UNIT

(71) Applicant: BASF SE, Ludwigshafen am Rhein (DE)

(72) Inventors: Michael Kroeger, Muenster (DE); Jens Roeder, Ludwigshafen (DE); Volker Boehm, Frankenthal (DE); Maximilian Hemgesberg, Leverkusen (DE); Denis Schwall, Ludwigshafen (DE); Christian Mayer, Ludwigshafen (DE); Thilo Cunz, Heidelberg (DE); Moritz Diesner, Mannheim (DE)

(21) Appl. No.: 16/096,452

(22) PCT Filed: Apr. 26, 2017
(86) PCT No.: PCT/EP2017/059841

§ 371 Date: Oct. 25, 2018

(30) Foreign Application Priority Data
Apr. 27, 2016 (EP) 16167247.2
Sep. 19, 2016 (EP) 16189507.3

(51) Int. Cl. F21V 8/00; B32B 17/10

(52) U.S. Cl. CPC G02B 6/0035; G02B 6/0065; G02B 6/0095; B32B 17/10761; B32B 17/10541; B32B 17/10669; B32B 17/10036

(57) ABSTRACT

A lighting unit in the form of laminated layers including a first layer (A), and a second layer (B). At least one of the layers (A) or (B) is optically transparent and the layers (A) and (B) are arranged parallel to each other. At least one functional interlayer (C) is arranged between the layers (A) and (B) and arranged parallel to the layers (A) and (B). The lighting unit includes at least one light source. Preparation of the lighting unit is disclosed. The lighting unit is suitable for use in buildings, furniture, cars, trains, planes and ships as well as in facades, skylights, glass, roofs, stair treads, glass bridges, canopies and railings.

The present invention concerns a lighting unit in form of laminated layers comprising a layer (A), a layer (B), wherein at least one of the layers (A) or (B) is optically transparent and the layers (A) and (B) are arranged parallel to each other, at least one functional interlayer (C), arranged between the layers (A) and (B) and arranged parallel to the layers (A) and (B) and at least one light source; the preparation of said lighting unit and the use of said lighting unit in buildings, furniture, cars, trains, planes and ships as well as in facades, skylights, glass, roofs, stair treads, glass bridges, canopies and railings.

Glass panels or laminated units comprising at least one optically transparent layer are used for example as surfaces which may be optionally transparent in building and furniture and in the automotive and aeronautic field as well as for decoration purposes, information purposes or advertising purposes.

Laminated safety glass, comprising sheets of glass and plastic, are used in areas where structural integrity after fracture is highly desired or required for safety reasons, especially but not exclusive in the fields of architectural glazing or automotive glazing.

The surface may be used for this purpose in illuminated form or in not illuminated form, where the illumination may be produced by suitable light sources. It is possible that the complete surface is illuminated, but it is also possible to apply pattern onto the surface. It is further possible to use different light sources, whereby for example colored or blocked lighting effects are produced. The surfaces may be used for example in buildings, furniture, cars, trains, planes an ships as well as in facades, skylights, glass roofs, stair treads, glass bridges, canopies and railings.

US 2015/308659 A1 concerns a glazing unit which includes sheets of glass and of plastic laminated between the glass sheets, and luminophores, wherein the glazing unit includes at least three glass sheets and at least two plastic films inserted in alternation between the glass sheets. The selection of at least three glass sheets associated with at least two intermediate films of plastic allows a three-dimensional image to be obtained.

US 2013/0252001 A1 concerns a laminated glazing for information display comprising an assembly of at least two transparent sheets of inorganic glass or of a strong organic material, joined together by an interlayer of a thermoformable material or by multilayer foils incorporating such interlayers, whereby said glazing being characterized in that a luminophore material of the hydroxyterephthalate type, combined with an antioxidant additive, is added into said interlayer. Further, in US 2013/0252001 A1 a device for displaying an image on transparent glazing is disclosed, comprising a laminated glazing as mentioned before and a source generating concentrated UV radiation of the laser type.

DE 10 2005 061 885 A1 concerns a glass element being part of a facade of a building with a long afterglow effect based on an element with a long afterglow effect with inorganic long afterglow pigments in a matrix, whereby the long afterglow element is graphically designed and applied to the glass element by screen printing or transfer technique, whereby the glass element is formed from at least two glass elements together with a carrier element, and the at least two glass elements form a laminated safety glass.

DE 10 2009 006 856 A1 concerns a glass comprising at least one integrated light field and a process for the preparation thereof and its use.

WO 2007/023083 concerns a glass assembly comprising phosphorescent, luminescent substance and two outer cover glass parts, which are indirectly or directly connected, between which the luminescent substance is sandwiched.

EP 2 110 237 concerns the preparation and use of photoluminescent intermediate layers as well as the use of said layers in laminated glass or photovoltaic modules.

The glass or lighting elements known in the prior art suffer from the drawback that the preparation of the lighting unit respectively the interlayer in the laminated glass is complicated, and the lighting units obtained are therefore expensive. When illuminated, glass sheets larger than 50 cm in one direction usually exhibit inhomogeneous color and light intensity due to light absorption and greenish color of glass sheets.

It is an object of the present invention over the prior art to provide a lighting unit with desired light color and light intensity distribution in form of laminated layers which is easy to prepare especially based on elements known in the prior art and therefore not expensive. The lighting unit should further provide improved structural stability before and after fracture.

This object is achieved by a lighting unit in form of laminated layers comprising
a) a layer (A);
b) a layer (B);

wherein at least one of the layers (A) or (B) is optically transparent, and the layers (A) and (B) are arranged parallel to each other,
c) at least one functional interlayer (C), arranged between the layers (A) and (B) and arranged parallel to the layers (A) and (B);
d) at least one light source (D),

arranged at an edge of the laminated layers,

wherein the functional interlayer (C) comprises luminous particles.

The advantage of the lighting unit according to the present invention is that said lighting unit is preparable from elements known in the art. A further advantage is the structural stability of the lighting unit according to the present invention. Especially, the functional interlayer (C) is based on layers usually used in laminated safety glasses. It has been found, that such an interlayer can easily be functionalized by luminous particles based on elements known in the prior art. By integrating a light source (D) into the lighting unit, lighting units can be prepared which are useful in the architectural, e.g. buildings and furniture, or automotive or aeronautic field.

It has further been found by the inventors that the lighting unit according to the present invention is characterized by the emission of light in high color homogeneity, especially in the case of large displays comprising the inventive lighting unit.

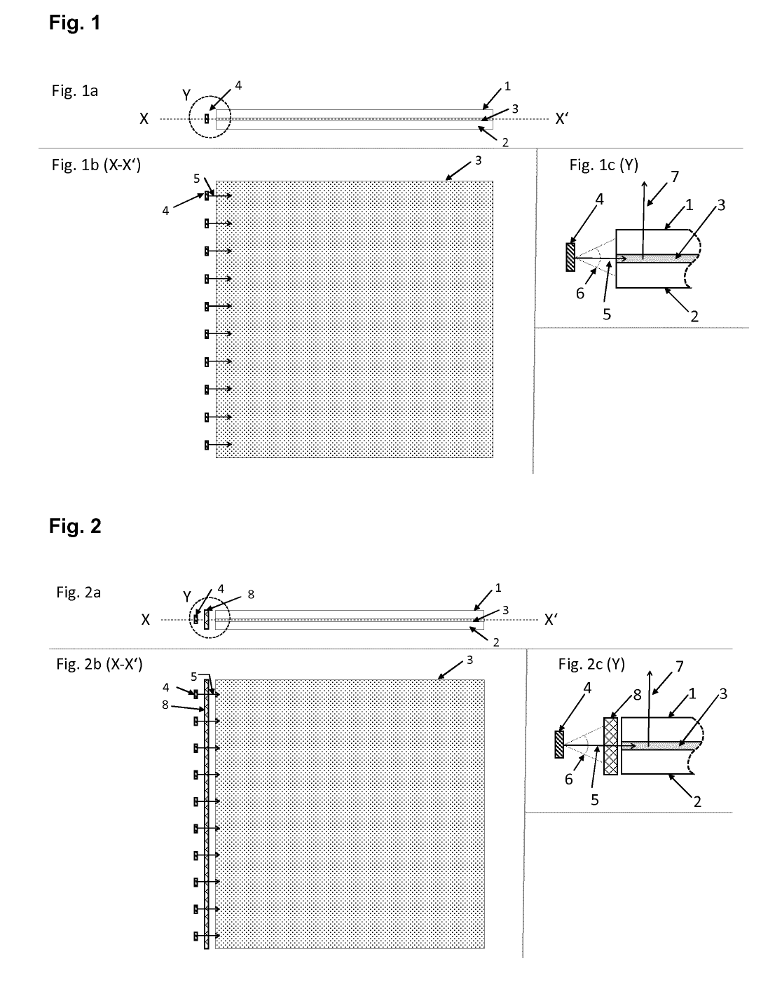

In FIGS. 1 to 4 preferred embodiments of lighting units according to the present application are shown.

In FIG. 1 one embodiment of a lighting unit according to the present invention is shown.

FIG. 1a shows a side view, wherein X and X′ identify the viewing direction and Y is a detail shown in figure 1c.

1 is the layer (A)

2 is the layer (B)

3 is the functional interlayer (C) comprising luminous particles, preferably in form of a printed luminous pattern

4 is the light source, preferably LED(s)

In FIG. 1b a cross sectional view of the lighting unit according to FIG. 1a (X-X′) is shown.

3 is the functional interlayer (C) comprising luminous particles, preferably in form of printed luminous pattern

4 is the light source (D), preferably LED(s)

5 is the main direction of the light beams from the light source, preferably LED(s)

In FIG. 1c detail Y (see FIG. 1a) is shown.

1 is the layer (A)

2 is the layer (B)

3 is the functional interlayer (C) comprising luminous particles, preferably in form of printed luminous pattern

4 is the light source, preferably LED(s)

5 is the main direction of the light beams emitted from the light source, preferably LED(s)

6 is the angle of radiation (half-value angle)

7 is one direction of light beams emitted from the luminous particles comprised in the functional interlayer (C)

In FIG. 2 a further embodiment of a lighting unit according to the present application is shown.

FIG. 2a shows a side view of the lighting unit in the viewing direction: X, X′ and Y is a detail shown in FIG. 2c.

1 is the layer (A)

2 is the layer (B)

3 is the functional interlayer (C) comprising luminous particles, preferably in form of printed luminous pattern

4 is the light source (D) preferably LED(s)

8 is an optical element, for example a cylindrical lens

In FIG. 2b a cross sectional view (X-X′) is shown.

3 is the functional interlayer (C) comprising luminous particles, preferably in form of printed luminous pattern

4 is the light source (D), preferably LED(s)

5 is the main direction of the light beams emitted from the light source, preferably LED(s)

8 is an optical element, for example a cylindrical lens

In FIG. 2c, detail Y (see FIG. 2a) is shown.

1 is the layer (A)

2 is the layer (B)

3 is the functional interlayer (C) comprising luminous particles, preferably in form of printed luminous pattern

4 is the light source (D), preferably LED(s)

5 is the main direction of the light beams emitted from the light source, preferably LED(s)

6 is the angle of radiation (half-value angle)

7 is one direction of light beams emitted from the luminous particles comprised in the functional interlayer (C)

8 is an optical element, for example a cylindrical lens

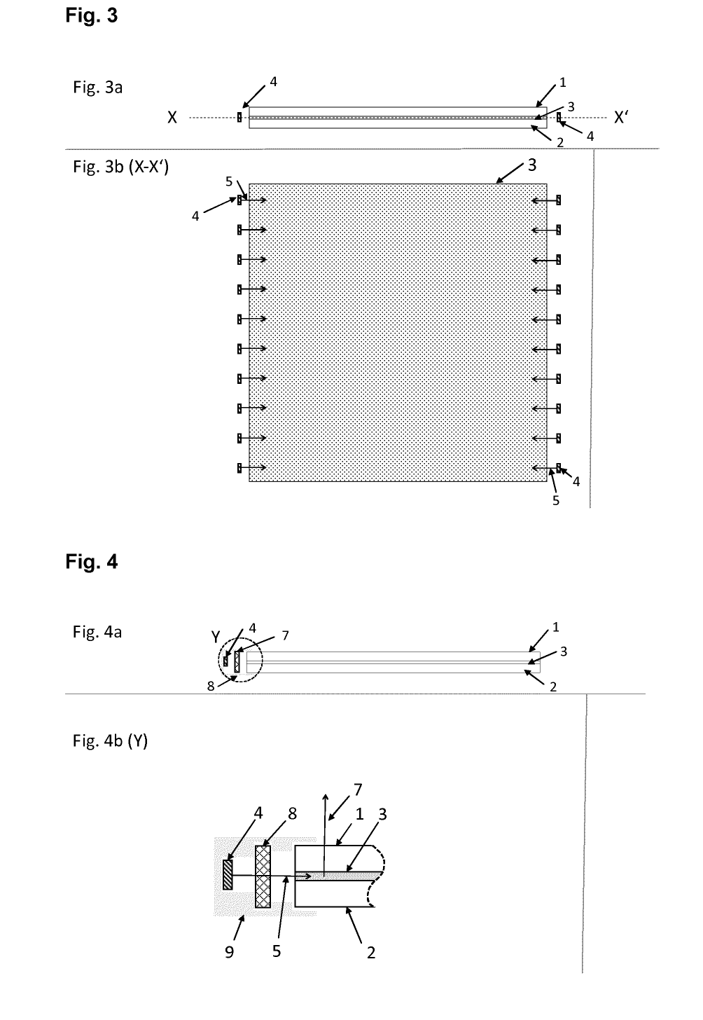

FIG. 3 shows a further embodiment of the inventive lighting unit.

FIG. 3a shows a side view in X-X′ direction.

1 is the layer (A)

2 is the layer (B)

3 is the functional interlayer (C) comprising luminous particles, preferably in form of printed luminous pattern

4 is the light source, preferable LED(s)

In FIG. 3b a cross sectional view (X-X′) is shown.

3 is the functional interlayer (C) comprising luminous particles, preferably in form of printed luminous pattern

4 is the light source, preferably LED(s)

5 is the main direction of the light beams emitted from the light source, preferably LED(s)

In FIG. 4a further embodiment of the inventive lighting unit is shown.

In FIG. 4a a side view is shown.

1 is the layer (A)

2 is the layer (B)

3 is the functional interlayer (C) comprising luminous particles, preferably in form of printed luminous pattern

4 is the light source (D), preferably LED(s)

7 is one direction of light beams emitted from the luminous particles comprised in the functional interlayer (C)

8 is an optical element, for example a cylindrical lens

9 is profile, a profile guide rail or an LED profile

Y is a detail shown in FIG. 4b

In FIG. 4b detail Y (see FIG. 4a) is shown.

1 is the layer (A)

2 is the layer (B)

3 is the functional interlayer (C) comprising luminous particles, preferably in form of printed luminous pattern

4 is the light source (D), preferably LED(s)

5 is the main direction of the light beam(s)

7 is one direction of light beams emitted from the luminous particles comprised in the functional interlayer (C)

8 is an optical element, for example a cylindrical lens

9 is a profile, a profile guide rail or an LED profile

FIGS. 1, 2, 3 and 4 are preferred embodiments of the present application.

Layers (A) and (B)

The lighting unit of the present application comprises a layer (A) and a layer (B), wherein at least one of the layers (A) or (B) is optically transparent.

In the meaning of the present application optically transparent means completely optically transparent as well semi-transparent. Therefore, optically transparent means that at least 30% of the incident light enter through the layer (A) and/or (B), preferably 30% to 100%, more preferably at least 50%, even more preferably 50% to 100%, most preferably at least 80%, even more most preferably 80% to 100%.

The transparency (light transmission) of at least 30%, preferably 30% to 100%, more preferably at least 50%, even more preferably 50% to 100%, most preferably at least 80%, even more most preferably 80% to 100% is preferably determined as light transmission TL (380-780 nm) based on EN 410.

It is also possible that not the complete layer (A) and/or (B) is optically transparent, but only a part of layer (A) and/or (B).

It is also possible that the transparency is wavelength sensitive, i. e. optically transparent also means that the light transmission mentioned before is only for yellow light or only for green light or only for red light or only for blue light, but the light transmission is lower for light of other wavelengths. This is for example the case when layer (A) and/or layer (B) is a wavelength sensitive glass, for example a toned glass layer. It is also possible to use wavelength sensitive polymer layers, for example toned polymer layers.

Suitable optically transparent materials for layers (A) and/or (B) are based on glass or transparent polymers, preferably glass, more preferably low-iron glass, or preferably PVC (polyvinylchloride), PMMA (polymethyl methacrylate), PC (polycarbonate), PS (polystyrene), PPO (polypropylene oxide), PE (polyethylene), PEN (polyethylene naphthalate), PP (polypropylene), PET (polypropylene terephthalate), PES (polyether sulfons), PI (polyimides) and mixtures thereof.

Preferably, the at least one optically transparent layer (A) and/or (B) is selected from glass, or PMMA (polymethyl methacrylate).

The optically transparent layer (A) and/or (B) might be coated with a functional layer for example but not limited to: color effect coating, low-e coating, mirror coating, partially silvered mirror coating, partially transparent mirror coating.

The optically transparent layer (A) and/or (B) might have an additional imprint.

An additional film might be on the optically transparent layer (A) and/or (B). The film might be imprinted, having a certain optical transparency eg. but not limited to for advertisements using the invention as backlight.

Suitable glasses and polymers are commercially available or preparable by processes known in the art. Preferred polystyrenes and polycarbonates are the polystyrenes and polycarbonates mentioned as matrix (i) in the luminous particles and are described below.

The further layer (A) and/or (B) which is optionally not transparent may be for example a polished glass (metal coated glass), a metal foil, a metal sheet or frosted glass, respectively partially frosted glass. Further, non transparent polymer layers may be used.

However, preferably both layers (A) and (B) are optically transparent and selected from an optically transparent material mentioned before.

At least one of the layers (A) or (B) may comprise one or more functional features like a coating or printing for decorative or informative purposes, a sensor element for pressure (touch panel), heat, light, humidity, pH-value -for example to switch the light source-, or an integrated solar cell or a solar cell foil, for example for power supply of the light source.

The layer (A) and the layer (B) usually have independently of each other a thickness of 0.1 to 50 mm, preferably 0.5 to 30 mm, more preferably 1.5 to 12 mm.

The area of the layers (A) and (B) may be the same or different and is preferably the same. The area is usually 0.05 to 25 m², preferably 0.08 to 15 m², more preferably 0.09 to 10 m².

At least one dimension of layers (A) and (B) is usually 0.1 to 10 m, preferably 0.25 to 5 m, more preferably 0.3 to 3 m.

Functional Interlayer (C)

The at least one functional interlayer (C) is arranged between the layers (A) and (B) and arranged parallel to the layers (A) and (B). Said functional interlayer (C) comprises luminous particles.

The functional interlayer (C) may be of any material which is useful in laminated glass. Therefore, suitable materials for the functional interlayer (C) are known by a person skilled in the art. The advantage of the present invention is that material for the layers (A), (B), and (C) may be used which are usually employed in laminated glass.

Preferably, the functional interlayer (C) is based on a ionomer (ionoplast), acid copolymers of α-olefins and α,β-ethylenically unsaturated carboxylic acids, ethylene vinyl acetate (EVA), polyvinyl acetal (for example poly(vinylbutyral)) (PVB), including acoustic grades of poly(vinyl acetal), thermoplastic polyurethane (TPU), polyvinyl chloride (PVC), polyethylenes (for example metallocene-catalyzed linear low density polyethylenes), polyolefin block elastomers, ethylene acrylate ester copolymers (for example poly(ethylene-co-methyl-acrylate) and poly(ethylene-co-butyl acrylate)), silicone elastomers, epoxy resins and mixtures thereof.

Suitable ionomers are derived from acid copolymers. Suitable acid copolymers are copolymers of α-olefins and α,β-ethylenically unsaturated carboxylic acids having 3 to 8 carbon atoms. The acid copolymers usually contain at least 1% by weight of α,β-ethylenically unsaturated carboxylic acids based on the total weight of the copolymers. Preferably, the acid copolymers contain at least 10% by weight, more preferably 15% to 25% by weight and most preferably 18% to 23% by weight of α,β-ethylenically unsaturated carboxylic acids based on the total weight of the copolymers.

The α-olefins mentioned before usually comprise 2 to 10 carbon atoms. Preferably, the α-olefins are selected from the group consisting of ethylene, propylene, 1-butene, 1-pentene, 1-heptene, 1-hexene, 3-methyll-butene, 4-methyl-1-pentene and mixtures thereof. More preferably, the α-olefin is ethylene. The α,β-ethylenically unsaturated carboxylic acids are preferably selected from the group consisting of acrylic acid, methacrylic acid, itaconic acid, maleic acid, maleic anhydride, fumaric acid, monomethyl maleic acid and mixtures thereof, preferably acrylic acid, methacrylic acid and mixtures thereof.

The acid copolymers may further contain other unsaturated copolymers like methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethyl hexyl acrylate, 2-ethyl hexyl methacrylate, isobornyl acrylate, isobornyl methacrylate, lauryl acrylate, lauryl methacrylate, 2-hydroxy ethyl acrylate, 2-hydroxy ethyl methacrylate, glycidyl acrylate, glycidyl methacrylate, poly(ethylene glycol) acrylate, polyethylene glycol (meth)acrylate, poly(ethylene glycol) methylether acrylate, poly(ethylene glycol) methylether methacrylate, poly(ethylene glycol) ether methacrylate, poly(ethylene glycol)behenyl ether acrylate, poly(ethylene glycol)behenyl ether methacrylate, poly(ethylene glycol)4-nonylphenylether acrylate, poly(ethylene glycol)4-nonylphenylether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimenthyl fumarate, vinyl acetate, vinyl propionate, and mixtures thereof. Preferably, the other unsaturated comonomers are selected from the group consisting of methyl acrylate, methyl methacrylate, butyl acrylate, butyl methacrylate, glycidyl methacrylate, vinyl acetate and mixtures thereof. The acid copolymers may comprise up to 50% by weight, preferably up to 30% by weight, more preferably up to 20% by weight of other unsaturated copolymers, based on the total weight of the copolymer.

The preparation of the acid copolymers mentioned before is known in the art and described for example in U.S. Pat. Nos. 3,404,134, 5,028,674, 6,500,888, and 6,518,635.

To obtain the ionomers, the acid copolymers are partially or fully neutralized with metallic ions. Preferably, the acid copolymers are 10% to 100%, more preferably 10% to 50%, most preferably 20% to 40% neutralized with metallic ions, based on the total number of moles of carboxylate groups in the ionomeric copolymer. The metallic ions may be monovalent, divalent, trivalent or multivalent or mixtures of said metallic ions. Preferable monovalent metallic ions are sodium, potassium, lithium, silver, mercury, copper and mixtures thereof. Preferred divalent metallic ions are beryllium, magnesium, calcium, strontium, barium, copper, cadmium, mercury, tin, lead, iron, cobalt, nickel, zinc, and mixtures thereof. Preferred trivalent metallic ions are aluminum, scandium, iron, yttrium and mixtures thereof. Preferred multivalent metallic ions are titanium, zirconium, hafnium, vanadium, tantalum, tungsten, chromium, cerium, iron and mixtures thereof. It is preferred that when the metallic ion is multivalent, complexing agents, such as stearate, oleate, salicylate and phenylate radicals are included (see U.S. Pat. No. 3,404,134). More preferred metallic ions are selected from the group consisting of sodium, lithium, magnesium, zinc, aluminum and mixtures thereof. Furthermore preferred metallic ions are selected from the group consisting of sodium, zinc and mixtures thereof. Most preferred is zinc as a metallic ion. The acid copolymers may be neutralized as disclosed for example in U.S. Pat. No. 3,404,134.

The ionomers usually have a melt index (MI) of, less than 10 g/10 min, preferably less than 5 g/10 min, more preferably less than 3 g/10 min as measured at 190° C. by ASTM method D1238. Further, the ionomers usually have a flexural modulus, greater than 40000 psi, preferably greater than 50000 psi, more preferably greater than 60000 psi, as measured by ASTM method D638.

The ionomer resins are typically prepared from acid copolymers having a MI of less than 60 g/10 min, preferably less than 55 g/10 min, more preferably less than 50 g/10 min, most preferably less than 35 g/10 min, as determined at 190° C. by ASTM method D1238.

Suitable ionomers are mentioned in U.S. Pat. No. 8,080,726 B2.

Preferably, the functional interlayer (C) is based on an ionomer, whereby preferred ionomers are mentioned before, polyvinylbutyral (PVB), polyvinylacetal, ethylene-vinylacetate (EVA), ethylene/vinylalcohol/vinylacetal copolymer and epoxy pouring resins. Commercial materials for the functional interlayer (C) are Trosifol®, Butacite®, Saflex®, SLec®, and SentryGlas®.

The thickness of the functional interlayer (C) is usually from 0.05 mm to 10 mm, more preferably from 0.2 mm to 6 mm, most preferably from 0.3 mm to 5 mm.

The area of the functional interlayer (C) may be identical with or different from the area of the interlayer (A) and/or (B). Preferably, the area of layers (A), (B) and functional interlayer (C) are identical. Suitable areas for the functional interlayer (C) are the same as mentioned for layers

(A) and (B). The functional interlayer may be comprised by several pieces of functional interlayer of smaller area, tiled side-by-side to be combined to become one larger functional interlayer. The functional interlayer (C) comprises luminous particles and is therefore described as functional interlayer (C).

It is further possible that the luminous particles are present in or on the interlayer (C) in form of a gradient, i.e., the amount of the luminous particles in or on the interlayer (C) varies, depending on the distance to at least one light source (D). For example the area of the functional interlayer (C) which is covered by luminous particles linearly scales with increasing distances to one light source (D).

The luminous particles may cover the complete interlayer (C), i. e. 100% of the area of the functional interlayer (C). However, it is also possible that only a part of the functional interlayer (C) is covered by luminous particles. Therefore, for example 0.5 to 50%, preferably 1 to 40%, more preferably 2 to 30%, most preferably 3 to 25% and even most preferably 4 to 20% of the functional interlayer (C) are covered by luminous particles.

The luminous particles may be present on/in the functional interlayer (C) in form of patterns or in form of a uniform coating.

The luminous particles are usually present on the interlayer (C) in a thickness 100 nm to 50 μm, preferably 5 μm to 20 μm.

According to the present invention it is possible that there is one functional interlayer (C) arranged between the layers (A) and (B). However, it is also possible that more than one functional interlayers (C) are arranged between the layers (A) and (B), especially two, three or four functional interlayers (C). The functional interlayers (C) are—in the case that more than one functional interlayer (C) is present—preferably different from each other.

Luminous Particles

The luminous particles which are present in the functional interlayer (C) preferably comprise:

i) at least one matrix (i); and

one or both of the following components (ii) and (iii):

ii) at least one luminophore (ii);

iii) at least one grit (iii).

In one preferred embodiment, the functional interlayer (C) comprises at least one matrix (i) and at least one luminophore (ii).

In a further preferred embodiment, the functional interlayer (C) comprises at least one matrix (i) and at least one grit (iii).

In a further preferred embodiment, the functional interlayer (C) comprises at least one matrix (i), at least one luminophore (ii) and at least one grit (iii).

There may be further components present in the luminous particles like plastizers, UV stabilizers, cross-linking agents, accelerants, photo-initiators, surfactants (preferably non polymeric dispersion agents), thixotropic modifiers.

Grit in the meaning of the present application is a scattering body.

In one embodiment, the luminous particles are present in the functional interlayer (C) in the form of agglomerates. Usually, said agglomerates have particle sizes of more than 400 nm.

Matrix (i)

The at least one matrix (i) present in the luminous particles according to the present application may be of any material known by a person skilled in the art useful for such a matrix.

Suitable matrix materials are polymers. The polymers are usually inorganic polymers or organic polymers. Preferred are polymers, wherein the luminophore (ii) and/or the grit (iii) can be dissolved or homogeneously distributed without decomposition.

Suitable inorganic polymers are, for example, silicates or silicon dioxide. In the case of silicates or silicon dioxide, for example, this can be accomplished by deposition of the polymer from a waterglass solution.

Preferably, the matrix (i) comprises homo- or copolymers of: (meth)acrylates, i.e. polymethacrylates or polyacrylates, for example polymethyl(meth)acrylate, polyethyl(meth)acrylate or polyisobutyl(meth)acrylate; poly(vinyl acetal), especially poly(vinyl butyrate) (PVB), cellulose polymers like ethyl cellulose, nitro cellulose, hydroxy alkyl cellulose, poly(vinyl acetate), polystyrenes (PS), thermoplastic polyurethane (TPU), polyimides, polyethylene oxides, polypropylene oxides, polyamines, polycaprolactones, phosphoric acid functionalized polyethylene glycols, polyethylene imines, polycarbonates (PC), polyethylene terephthalate (PET), ethylene vinyl acetate (EVA), polyethylenes (for example metallocene-catalyzed linear low density polyethylenes), castor oil, polyvinylpyrrolidone, polyvinyl chloride, polybutene, silicone, epoxy resin, polyvinyl alcohol, polyacrylonitrile, polyvinylidene chloride (PVDC), polystyreneacrylonitrile (SAN), polybutylene terephthalate (PBT), polyvinyl butyrate (PVB), polyvinyl chloride (PVC), polyamides, polyoxymethylenes, polyimides, polyetherimide or mixtures thereof.

Preferred matrix materials (i) are selected from the group consisting of homo- or copolymers or (meth)acrylate, i.e. polymethylmethacrylate, polymethacrylate, polyacrylate, cellulose derivative like ethyl cellulose, nitro cellulose, hydroxy alkyl cellulose, polystyrenes, polycarbonates, polyethylene terephthalate (PET) or mixtures thereof.

Polyethylene terephthalate is obtainable by condensation of ethylene glycol with terephthalic acid.

Preferred matrix materials (i) are organic polymers consisting essentially of polystyrene and/or polycarbonate, more preferably, the matrix consists of polystyrene or polycarbonate.

Polystyrene is understood to include all homo- or copolymers which result from polymerization of styrene and/or derivative of styrene.

Derivatives of styrene are, for example, alkyl styrenes such as a-methyl styrene, ortho-meta-para-methylstyrene, para-butylstryrene, especially para-tert.-butystyrene, alkoxystyrene, such as para-methoxy styrene, para-butoxy styrene, especially para-tert.-butoxy styrene.

In general suitable polystyrenes have a mean molar mass Mₙ of 10000 to 1000000 g/mol (determined by GPC), preferably 20000 to 750000 g/mol, more preferably 30000 to 500000 g/mol.

In one preferred embodiment, the matrix (i) consists essentially of or completely of the homopolymer of styrene or derivatives of styrene.

In a further preferred embodiment the matrix (i) consists essentially of or completely of a styrene copolymer which, in the context of this application, is likewise considered to be polystyrene. Styrene copolymers may comprise as further constituents, for example butadiene, acrylonitrile, maleic anhydride, vinyl carbazoles or esters of acrylic acid, methacrylic acid or itacrylic acid as monomers. Suitable styrene copolymers comprise generally at least 20% by weight of styrene, preferably at least 40% by weight of styrene and more preferably at least 60% by weight of styrene. In another embodiment, they comprise at least 90% by weight of styrene.

Preferred styrene copolymers are styrene-acrylonitrile copolymers (SAN) and acrylonitrile-butadiene styrene copolymers (ABS), styrene-1,1-diphenylethylene copolymers, acrylic ester-styrene-acrylonitrile copolymers (ASA), methyl methacrylate-acrylonitrile-butadiene styrene co-polymers (MABS) and a-methyl styrene-acrylonitrile copolymer (AMSAN).

The styrene homo- or copolymers can be prepared for example by free-radical polymerization, cationic polymerization, anionic polymerization, or under the influence of organometallic catalysts (for example Ziegler-Natta-catalysts). This can lead to isotactic, syndiotactic, atactic polystyrene or copolymers. They are preferably prepared by free-radical polymerization. The polymerization can be performed as a suspension polymerization, emulsion polymerization, solution polymerization or bulk polymerization.

The preparation of suitable polystyrenes is described for example in Oskar Nuyken, Polystyrenes and Other Aromatic Polyvinyl Compounds; in Kricheldorf, Nuyken, Swift, New York, 2005, p. 73 to 150, and references cited therein; and in Elias, Macromolecules, Weinheim 2007, p. 269 to 275.

Polycarbonates are polyesters of carbonic acid with aromatic or aliphatic dihydroxyl compounds. Preferred dihydroxyl compounds are for example methylene, diphenylene, dihydroxyl compounds, for example bisphenol A.

One means of preparing polycarbonates is the reaction of suitable dihydroxyl compounds with phosgenes in an interfacial polymerization. Another means is the reaction with diesters of carbonic acid, such as diphenyl carbonate, in a condensation polymerization.

The preparation of suitable polycarbonates is described for example, in Elias, Macromolecules, Weinheim 2007, p. 343 to 347.

In a preferred embodiment, polystyrenes or polycarbonates which have been polymerized with the exclusion of oxygen are used. The monomers preferably comprise, during polymerization, a total of at most 1000 ppm of oxygen, more preferably at most 100 ppm and especially preferably at most 10 ppm.

The preparation of the polycarbonates and polystyrenes mentioned above as well as the preparation of the other compounds mentioned as matrix material (i) according to the present invention is known by a person skilled in the art. Generally, the matrix materials (i) mentioned above, are commercially available.

Suitable matrix materials, especially suitable polystyrenes and/or polycarbonates, may comprise, as further constituents, additives such as flame retardants, antioxidants, light stabilizers, free-radical scavengers, antistats. Such further constituents are known to those skilled in the art and usually commercially available.

In one embodiment of the present invention, polystyrenes or polycarbonates used as matrix (i) which do not comprise any antioxidants or free-radical scavengers.

In one further embodiment of the present invention the matrix materials (i), especially the polystyrenes or polycarbonates, are transparent polymers.

In another embodiment, suitable matrix materials (i), especially suitable polystyrenes or polycarbonates, are opaque polymers.

In one embodiment of the present invention, the matrix (i) consists essentially of or completely of a mixture of polystyrene and/or polycarbonate with other polymers, but the matrix (i) preferably comprises at least 25% by weight, more preferably at least 50% by weight, most preferably at least 70% by weight of polystyrene and/or polycarbonate.

In another embodiment, the matrix consists essentially of or completely of polystyrene or polycarbonate or a mixture of polystyrene and polycarbonate in any ratio.

It is possible that the polystyrenes, respectively the polycarbonates are employed as mixtures of different polystyrenes, respectively different polycarbonates.

The matrix (i) may be mechanically reinforced for example with glass fibers.

Luminophore (ii)

Luminophores in the sense of the present application are photoluminescent compounds, whereby said compounds may be fluorescent or phosphorescent. Preferred luminophores according to the present invention show the following features:
Exitation by light;
High luminescence (i. e. fluorescence or phosphorescence) after excitation; preferred are photoluminescence quantum yields of 50% to 100%, more preferred of 70% to 100%, most preferred of 80% to 100%;
An absorption spectrum in the ultraviolet and visible region of the electromagnetic spectrum, with a maximum absorption at a wavelength of 250-800 nm, more preferably 350-550 nm, most preferably 400-475 nm.
An emission spectrum in the visible region of the electromagnetic spectrum with a maximum emission at a wavelength at 400-800 nm, more preferably 410-750 nm, most preferably 430-630 nm.

Suitable luminophores are preferably selected from inorganic luminescent colorants and/or organic luminescent colorants, whereby luminescent means fluorescent or phosphorescent.

Preferred inorganic luminescent colorants are those from the class of the rare earth-doped aluminates, silicates, nitrides and garnets. Further inorganic luminescent colorants are, for example, those mentioned in “Luminescence—from Theory to Applications”, Cees Ronda [ed.], Wiley-VCH, 2008, Chapter 7, “Luminescent Materials for Phosphor—Converted LEDs”, Th. Justel, pages 179-190.

Garnets are compounds of the general formula X₃Y₂[ZO₄]₃ in which Z is a divalent cation such as Ca, Mg, Fe, Mn, Y is a trivalent cation such as Al, Fe, Cr, rare earths, and Z is Si, Al, Fe³⁺, Ga³⁺. The garnet is preferably yttrium aluminum garnet Y₃Al₅O₁₂ doped with Ce³⁺, Gd³⁺, Sm³⁺, Eu²⁺, Eu³⁺, Dy³⁺, Tb³⁺ or mixtures thereof.

Suitable nitrides are described, for example, in U.S. Pat. No. 8,274,215. Suitable silicates are described, for example, in U.S. Pat. Nos. 7,906,041 and 7,311,858.

Suitable aluminates are described, for example, in U.S. Pat. No. 7,755,276.

Suitable aluminate phosphors of the formula SrLu₂₋ₓAl₄O₁₂: Ceₓ in which x is a value from the range from 0.01 to 0.15 are known from WO2012010244. Luminescent colorants of the composition MLn₂QR₄O₁₂ where M is at least one of the elements Mg, Ca, Sr or Ba, Ln is at least one of the elements Sc, Y, La, Ce, Pr, Nd, Sm, Eu, Gd, Tb, Dy, Ho, Er, Tm, Yb and Lu; Q is one of the elements Si, Ge, Sn, and Pb, and R, finally, is at least one of the elements B, Al, Ga, In and TI are known from US 2004/0062699.

Further preferred inorganic luminescent colorants are silicate-based phosphors of a general composition A₃Si(O,D)₅ or A₂Si(O,D)₄, in which Si is silicone, O is oxygen, A comprises strontium (Sr), barium (Ba), magnesium (Mg) or calcium (Ca) and D comprises chlorine (CI), fluorine (F), nitrogen (N) or sulfur, aluminum-based phosphors, aluminum-silicate-based phosphors, nitride-based phosphors, sulfate phosphors, oxy-nitride phosphors, oxy-sulfate phosphors, garnet materials, iron oxides, titanium dioxide, lead chromate pigments, lead molybdate pigments, nickel titanium pigments or chromium oxide or mixtures thereof.

Suitable inorganic pigments are for example described in U.S. Pat. No. 8,337,02962 and in EP 2 110 237 A1.

More preferred inorganic luminescent colorants are yttrium aluminum garnets (Y₃Al₅O₁₂), cerium-doped yttrium aluminum garnets (Y₃Al₅O₁₂: Ce³⁺), ASiO : EuF (wherein A is defined above and EuF is doped into AbiO), preferably A is Sr, Ba and C or Ca, BaEuAO: F (wherein F is doped into BaEu AlO) and MgAlZr : CeF (wherein CeF is doped into MgAlZr).

Preferred organic luminescent colorants are organic luminescent pigments or organic luminescent dyes, for example functionalized naphthalene derivatives or functionalized rylene derivatives, for example naphthalene comprising compounds bearing one or more substituents selected from halogen, cyano, benzimidazole or one or more groups bearing carbonyl functions or perylene compounds bearing one or more substituents selected from halogen, cyano, benzimidazole, or one or more groups bearing carbonyl functions, heterocyclic hydrocarbons, cumarins, stilbenes, cyanines, rubrens, pyranines, rhodanines, phenoxazines, diazo compounds, isoindoline derivatives, monoazo compounds, anthrachinone pigments, thioindigo derivatives, azomethine derivatives, chinacridones, perinones, dioxazines, pyrazolo-chinazolones, polycyclic compounds comprising keto groups, phthalocyanines, varnished basic colorants, benzoxanthene or benzimidazoxanthenoisoquinolinone (suitable benzimidazoxanthenoisoquinolinones are for example described in WO 2015/062916A1) or inorganic quantum dots, especially based on CdSe, CdTe, ZnS, InP, PbS, CdS or mixtures thereof.

Inorganic quantum dots are for example described in WO 2013/078252 A1. Preferred inorganic quantum dots are based on CdSe, CdTe, ZnS, InP, PbS, CdS or mixtures thereof. The quantum dots usually have an average diameter of less than 100 nm, preferably less than 20 nm, more preferably less than 10 nm, for example 2 to 10 nm.

The luminophores (ii) are usually dispersed in the matrix (i) or solved in the matrix (i).

Most preferred inorganic pigments are cerium-doped yttrium aluminum garnets (Y₃Al₅O₁₂: Ce³⁺).

Most preferred organic components (dyes or pigments) are perylene dyes and or pigments, functionalized naphthalene dyes or functionalized rylene dyes, whereby suitable functions of the naphthalene dyes and rylene dyes are mentioned before.

Preferred perylene pigments and functionalized naphthalene dyes and rylene dyes are for example described in WO 2012/113884.

Further preferred organic dyes are cyanated naphthalene benzimidazole compounds as for example described in WO 2015/019270.

The organic dyes mentioned above are usually molecularly dissolved in the polymer matrix.

Suitable inorganic quantum dots usually have a mean particle size according to DIN 13320 of 2 to 30 nm.

Suitable inorganic pigments usually have a mean particle size according to DIN13320 of 0.5 to 50 μm, preferably 2 to 20 μm, even more preferably between 5 and 15 μm.

In a preferred embodiment, luminous particles comprise a combination of at least two luminophores or at least one luminophore and at least one grit. For example, the at least one inorganic or organic luminescent colorant can be combined with at least one further inorganic or organic luminescent colorant. In another example, at least one inorganic or organic luminescent colorant can be combined with at least one grit. In a preferred example, cerium-doped yttrium aluminum garnets (Y₃Al₅O₁₂: Ce³⁺) serve as inorganic luminescent colorant and are combined with yttrium aluminum garnets (Y₃Al₅O₁₂), serving as grit.

In a preferred embodiment, the colorants are combined with one another such that blue light can be converted to white light with a color temperature of 1500-8500 K and good color rendering.

In a preferred embodiment, the colorants and/or the grits are combined with one another such that white light (LED light) with a color temperature of 8000 to 15000 K can be converted to white light with a color temperature of 1500-7500 K and good color rendering.

In a further preferred embodiment the colorants and/or the grits are combined with one another such that blue light (LED light) with usually 440 to 475 nm peak wavelength can be converted to white light, for example by using a yellow converter.

In a further preferred embodiment the colorants and/or the grits are combined with one another such that red, green and blue light (LED light) can be converted to each color desired.

Grit (iii) (scattering bodies)

As at least one grit (iii) usually all suitable grit material known in the art can be employed.

Preferably, the grit (iii) is selected from particles comprising TiO₂, SnO₂, ZnO, Al₂O₃, Y₃Al₅O₁₂, ZrO₂, barium sulfate, lithopone, zinc sulfide, calcium carbonate and mixtures thereof.

The grits (iii) are usually colored (for example red, green or blue) pigments or white pigments. Preferably, the grits (iii) are white pigments, preferably selected from TiO₂, ZnO, Al₂O₃, Y₃Al₅O₁₂, barium sulfate, lithopone, zinc sulfide, calcium carbonate and mixtures thereof.

Usually, the grit (iii) has a mean particle size according to DIN 13320 of 0.01 to 30 μm, preferably 0.5 to 10 μm, more preferably 1 to 10 μm.

In a preferred embodiment of the present invention, the luminous particles in the functional interlayer (C) comprise
i) at least one matrix (i), selected from polystyrene, polycarbonate, ethyl cellulose, nitro cellulose, hydroxyl alkyl cellulose, poly(meth)acrylate, copolymers comprising (meth)acrylate or mixtures thereof; and

one or both of the following components (ii) and (iii):
ii) at least one luminophore (ii) selected from cerium-doped yttrium aluminum garnet, perylene dyes, functionalized naphthalene dye, functionalized rylene dyes, cyanated naphthalene benzimidazole compounds or mixtures thereof;
iii) at least one grit (iii) selected from TiO₂, ZnO, Al₂O₃, Y₃Al₅O₁₂ and mixtures thereof.

Preferably, the lighting unit according to the present application comprises in the functional interlayer (C) luminous particles, wherein said luminous particles comprise 0.01 to 5% by weight, preferably 0.02 to 3% by weight, more preferably 0.05 to 2.5% by weight of at least one organic luminophore (ii), based in each case on the total amount of the luminous particles, which is 100% by weight—in the case that at least one organic luminophore (ii) is present in the luminous particles.

In a further preferred embodiment, the lighting unit according to the present application comprises in the functional interlayer (C) luminous particles, wherein said luminous particles comprise 0.5 to 60% by weight, preferably 2 to 55% by weight, more preferably 5 to 52% by weight of at least one inorganic luminophore (ii), based in each case on the total amount of the luminous particles, which is 100% by weight—in the case that at least one inorganic luminophore (ii) is present in the luminous particles.

The grit (iii) (scattering bodies) is typically present in the luminous particles in an amount of 0.01 to 50% by weight, preferably 0.05 to 20% by weight, more preferably 0.1 to 4% by weight, based in each case on the luminous particles which are 100% by weight—in the case that at least one grit (iii) is present in the luminous particles.

The luminous particles preferably comprise
i) 45% by weight to 99.99% by weight, 77% by weight to 99.93% by weight, more preferably 93.5% to 99.85% by weight of at least one matrix (i),
ii) 0.01 to 5% by weight, preferably 0.02 to 3% by weight, more preferably 0.05 to 2.5% by weight of at least one organic luminophore (ii),
iii) 0 to 50% by weight; preferably 0.05 to 20% by weight; more preferably 0.1 to 4% by weight of at least one grit (iii);

wherein the sum of all components (i), (ii) and (iii) is 100% by weight.

In a further preferred embodiment, the lighting unit according to the present application comprises in the functional interlayer (C) luminous particles, wherein said luminous particles comprise 0.5 to 60% by weight, preferably 1 to 55% by weight, more preferably 2 to 52% by weight of at least one inorganic luminophore (ii), based in each case on the total amount of the luminous particles, which is 100% by weight—in the case that at least one inorganic luminophore (ii) is present in the luminous particles.

The grit (iii) (scattering bodies) is typically present in the luminous particles in said further embodiment in an amount of 0.5 to 60% by weight, preferably 1 to 55% by weight, more preferably 2 to 52% by weight, based in each case on the luminous particles which are 100% by weight—in the case that at least one grit (iii) is present in the luminous particles.

The luminous particles preferably therefore comprise in a further embodiment
i) 15% by weight to 99.5% by weight, 30% by weight to 97.5% by weight, more preferably 38% to 97% by weight of at least one matrix (i),
ii) 0 to 60% by weight, preferably 1 to 55% by weight, more preferably 2 to 52% by weight of at least one inorganic luminophore (ii),
iii) 0 to 60% by weight, preferably 1 to 55% by weight, more preferably 2 to 52% by weight of at least one grit (iii);

wherein the sum of all components (i), (ii) and (iii) is 100% by weight.

Further interlayers (C′)

The lighting unit according to the present invention may comprise in addition to the layers (A), (B) and (C) at least interlayer (C′). Said interlayer (C′) is arranged between the layers (A) and (B) and arranged parallel to the layers (A) and (B) with direct contact to the functional interlayer (C). The interlayer (C′) is either arranged between the layers (A) and (C) or between the layers (C) and (B). It is possible that one interlayer (C′) is present or that more than one interlayer (C′), for example 2 or 3 interlayers (C′), are present. In the case that more than one interlayers (C′) are present, the functional interlayer (C) may be arranged between two interlayers (C′).

The interlayer (C′) may be of any material which is useful in laminated glass. Therefore, suitable materials for the interlayer (C′) are known by a person skilled in the art.

Suitable material for the interlayer (C′) is the material mentioned as material for the functional interlayer (C), i.e. the interlayer (C′) differs from the functional interlayer (C) in the absence of luminous particles.

The at least one interlayer (C′) usually has a thickness of 0.05 to 2 mm, preferably 0.1 to 1.8 mm, more preferably 0.3 to 1.6 mm. In the case that more than one interlayer (C′) is present, the interlayers (C′) have the same thickness or different thicknesses.

In one embodiment of the present invention the lighting unit therefore comprises:
a) a layer (A);
b) a layer (B);

wherein at least one of the layers (A) or (B) is optically transparent, and the layers (A) and (B) are arranged parallel to each other,
c) at least one functional interlayer (C), arranged between the layers (A) and (B) and arranged parallel to the layers (A) and (B);
c′) at least one interlayer (C′), arranged between the layers (C) and (B) and arranged parallel to the layers (C) and (B); and/or arranged between the layers (A) and (C) and arranged parallel to the layers (A) and (C);
d) at least one light source (D),

arranged at an edge of the laminated layers,

wherein the functional interlayer (C) comprises luminous particles.

Suitable and preferred materials and properties of the layers (A), (B) and (C) as well as suitable light sources (D) and suitable further components of the lighting unit are mentioned above and below.

In a preferred embodiment, the material of the interlayer (C′) is identical with the material of the functional interlayer (C).

At least one light source (D)

The light source (D) may be any light source known by a person skilled in the art as useful for lighting units.

Preferably, the light source (D) is selected from the group consisting of LEDs (light emitting diode), OLEDs (organic light emitting diode), laser and gas-discharge lamps. Preferably, the light source (B) is selected from the group consisting of LEDs and OLEDs, more preferred are LEDs.

Preferred light sources show a low power consumption, a low mounting depth and very flexible wavelength ranges, which can be chosen depending on the necessity (a small wavelength range or a broad wavelength range).

Suitable wavelength ranges for the light source (D) are for example 440 to 470 nm (blue), 515 to 535 nm (green) and 610 to 630 nm (red). Depending on the desired color of light, for example in the case of white light, light sources (D) with different wavelengths may be combined or light sources having the desired color of light (for example white light) can be employed. The emission spectrum of an OLED may for example selectively adjusted by the device structure of the OLED.

Therefore, the light source (D) preferably emits light in a wavelength range of 250 to 1000 nm, preferably of 360 to 800 nm. More preferably, the light source emits light with a wavelength (peak wavelength) of 360 to 475 nm.

The half width of the emission spectrum of the light source is for example less than 35 nm.

In the lighting unit according to the present invention one or more light sources can be used. Preferably, 1 to 200 light sources, more preferably 1 to 100 light sources, most preferably 1 to 50 light sources are used in the lighting unit according to the present application.

Said light sources emit in an identical wavelength range or in different wavelength ranges, i. e. said light sources emit with the same color of light or with different colors of light. Preferably, the light sources employed in the lighting unit according to the present application emit in the same color of light or in three different colors of light, i.e. usually red, green and blue. By combination of the emission of red, green and blue emitting light sources (D) desired different light colors can be adjusted.

The light source (D) preferably show a directional light radiation. The angle of radiation (half value angle) is preferably less than 120° more preferably less than 90° , most preferably less than 45°.

The lighting unit according to the present application comprises in a preferred embodiment at least one optical element (E) which is arranged between the at least one light source and the laminated layers, at the edge of said laminated layers. An example for said embodiment is shown in FIG. 2 and FIG. 4.

In the case that more than one light source is employed, it is possible to employ also more than one optical element, i.e. preferably as many optical elements as light sources are present.

Suitable optical elements are known by a person skilled in the art. Examples for suitable optical elements are lenses or cylindric lenses. The optical element(s) is (are) placed in the path of light emitted from the light source(s) into the edge of the laminated layers. The optical element(s) can be attached (e.g. glued) directly to the light source(s), or can be attached (e.g. glued) to one edge of the laminated layers, or can be attached to a profile, which fixes the position of light source(s), to the position optical element(s) and of laminated layers to each other (see for example FIG. 4).

In a further preferred embodiment, which may be combined with the preferred embodiment (the presence of at least one optical element) mentioned before, the lighting unit comprises at least one light source at each edge of two edges of the laminated layers, especially at two edges which are opposite to each other. An example for said embodiment is shown FIG. 3.

Lighting Unit

The lighting unit according to the present invention is in the form of laminated layers comprising

a) a layer (A);

b) a layer (B);

wherein at least one of the layers (A) or (B) is optically transparent, and the layers (A) and (B) are arranged parallel to each other,

c) at least one functional interlayer (C), arranged between the layers (A) and (B) and arranged parallel to the layers (A) and (B);

d) at least one light source (D),

arranged at an edge of the laminated layers,

wherein the functional interlayer (C) comprises luminous particles.

The lighting unit further optionally comprises at least one optical element (E).

The layers (A), (B), (C), the light source (D) and the optical element (E) are described before.

The layer thickness of the layer (A) is preferably 0.1 to 50 mm, more preferably 0.5 to 30 mm, most preferably 1.5 to 12 mm.

The layer thickness of layer (B) is preferably 0.1 to 50 mm, more preferably 0.5 to 30 mm, most preferably 1.5 to 12 mm.

The layer thickness of the functional interlayer (C) is preferably 0.03 to 10 mm, more preferably 0.04 to 6 mm, most preferably 0.05 to 5 mm.

The lighting unit preferably comprises one, two, three or four functional interlayers (C), preferably one or two and most preferably one functional interlayer (C).

Additionally, the lighting unit may comprise at least one interlayer (C′).

The at least one interlayer (C′) usually has a thickness of 0.05 to 2 mm, preferably 0.1 to 1.8 mm, more preferably 0.3 to 1.6 mm. In the case that more than one interlayer (C′) is present, the interlayers (C′) have the same thickness or different thicknesses.

The at least one light source (D) is arranged at an edge of the laminated layers. This means that the light source (D) is preferably arranged in a way that the radiation is irradiated parallel to the functional interlayer (C). Therefore, the light source is preferably arranged on the face side of the lighting unit. Suitable embodiments showing the arrangement of the lighting unit are shown in the figures.

Preferably the light source (D) is arranged in the middle of the total height of the lighting unit. Suitable positions of the light source are for example shown in the figures.

In the case of more than one light source or light sources are arranged as mentioned above.

In a cross-sectional view, the light sources are—in the case that more than one light source is employed—arranged in a line preferably with identical distance to the laminated layers of the lighting unit. More preferably, the light sources are arranged at at least one edge of the lighting unit. However, in a further preferred embodiment, the light sources are arranged at two edges of the laminated layers, preferably opposite to each other (see FIGS. 1, 2 and 3).

The number of light sources (D) usually depends on the desired luminous intensity and the efficiency of the light source and the area of the laminated layers.

In the case that the light sources are arranged at two edges of the laminated layers opposite to each other, it is possible to reduce inhomogeneities for example because of light absorption in the layers of the lighting unit.

In a further embodiment of the present application, between the light source and the laminated layers, an optical element (E) may be present, for example a cylindrical lens (see FIG. 2 and FIG. 4). With the optical element, it is possible to optimize the distribution of the light in the lighting unit. The optical element is usually arranged between the light source (D) and the laminated layers of the inventive lighting unit.

Preparation of the Lighting Unit

The preparation of the lighting unit according to the present application is usually carried out as known in the art.

Preferably, the process of preparing the lighting unit according to the present invention comprises the steps of:
i) applying luminous particles to a layer (C*), whereby the functional interlayer (C) is formed;
ii) laminating a layer (A) at least one functional interlayer (C) and a layer (B), wherein the layers (A), (C) and (B) are arranged parallel to each other, whereby the at least one layer (C) is arranged between layers (A) and (B);
iii) mounting the at least one light source (D) at an edge of the laminated layer.

The layers of the lighting unit are laminated by any process known in the art, for example by stacking of the layers of the lighting unit and laminating by for example placing it under vacuum in a vacuum bag and backing it in an autoclave, for example at 100 to 180° C. and for example at a pressure of from 2 to 20 bar and/or for example for 0.5 to 10 hours.

iii) Mounting the at least one light source (D) at an edge of the laminated layer

The light source is usually applied to the laminated layers after lamination as known by a person skilled in the art.

In one embodiment of the present application, the light source, as well as optional optical elements are fixed to the laminated layers by a profile, for example by an LED-profile.

i) Applying luminous particles to a layer (C*), whereby the functional interlayer (C) is formed

The functionalization of the layer (C*) with luminous particles is usually carried out by any known method, for example by printing, e.g. screen printing or inkjet printing, or by coating, e.g. slot-die, slit, roller, curtain coating or spraying. Preferably, the functionalization with the luminous particles is carried out by screen printing, inkjet printing, or slot-die coating.

The layer (C*) is identical with the functional interlayer (C) as defined before, except for the presence of the luminous particles. Preferred components of the functional interlayer (C) are described above and are also preferred components for the layer (C*).

In order to apply the luminous particles by screen printing, inkjet printing or slot dye coating, the luminous particles are usually applied to the layer (C*) in form of a printing formulation (ink). Said printing formulation comprises besides the luminous particles comprising at least one matrix (i), and one or both of the following components (ii) and (iii):

at least one luminophore (ii), at least one grit (iii) usually at least one solvent.

The at least one solvent is usually an organic solvent or a mixture of organic solvents, wherein the luminous particles are dissolved or dispersed.

Suitable solvents are for example alkanols, like n- and i-alkanols, for example Ehtanol, iso-Propanol, n-Propanol, n-Butanal; texanol; butylcarbitol; etherol or alcohol based acetates like butylcarbitol acetate, Methoxypropylacetat, Propylenglykolmethyletheracetat, Propylenglykoldiacetat; dipropylene glycol dimethyl ether; glyme, diglyme; or linear or branched alkyl acetates with 3 to 22 carbon atoms.

Said printing formulation is processed to the layer material (C*), for example by printing, e.g. screen printing or inkjet printing, or by coating, e.g. slot-die, slit, roller, curtain coating or spraying, whereby the luminous particles are preferably homogeneously distributed. It is also possible to apply the luminous particles only to a part of the layer (C*) or in form of pattern or in form of a gradient as mentioned above. Processes to apply the luminous particles only to a part of the layer (C*) or in form of pattern or in form of a gradient are known by a person skilled in the art.

After processing the luminous particles in form of a printing formulation to the layer (C*), the solvent is removed by a process known in the art, e.g. by heating under ambient or by heating under laminar gas flow, or by heating under controlled atmosphere e.g. under a vacuum.

Typical printing formulations are known by a person skilled in the art.

Preferred Printing Formulations Comprise:
(I) luminous particles comprising at least one matrix (i), and one or both of the following components (ii) and (iii): at least one luminophore (ii), at least one grit (iii), and
(II) at least one solvent.

Suitable and preferred luminous particles are mentioned before. Also, preferred and suitable organic solvents are mentioned before.

Examples for typical printing formulations are:

(i)

α-Terpineol (70 to 90% by weight, based on the total amount of the formulation), EFKA PX 4330 (70%) (0.1 to 5% by weight, based on the total amount of the formulation), Ce³⁺:YAG (e.g. Tailorlux TL 0036®) (5 to 15% by weight, based on the total amount of the formulation),

ETHOCEL Std 4 Industrial (0.5 to 10% by weight, based on the total amount of the formulation) and

DISPARLON 6700 (0.5 to 10% by weight, based on the total amount of the formulation).

(ii)

Diacetin (70 to 90% by weight),

EFKA PX 4330 (70%) (0.1 to 5% by weight, based on the total amount of the printing formulation),

Ce³⁺:YAG (e.g. Tailorlux TL 0036®) (5 to 15% by weight, based on the total amount of the printing formulation),

ETHOCEL Std 4 Industrial (0.5 to 10% by weight, based on the total amount of the printing formulation), and

DISPARLON 6700 (0.5 to 10% by weight, based on the total amount of the printing formulation).

(iii)

α-Terpineol (70 to 90% by weight, based on the total amount of the printing formulation), Solsperse 36000 (0.1 to 5% by weight, based on the total amount of the printing formulation), Ce³⁺:YAG (e.g. Tailorlux TL 0036®) (5 to 15% by weight, based on the total amount of the printing formulation),

ETHOCEL Std 4 Industrial (0.5 to 10% by weight, based on the total amount of the printing formulation), and

DISPARLON 6700 (0.5 to 10% by weight, based on the total amount of the printing formulation).

(iv)

α-Terpineol (70 to 90% by weight, based on the total amount of the printing formulation), Disperbyk 180 (0.1 to 5% by weight, based on the total amount of the printing formulation), Ce³⁺:YAG (e.g. Tailorlux TL 0036®) (5 to 15% by weight, based on the total amount of the printing formulation),

ETHOCEL Std 4 Industrial (0.5 to 10% by weight, based on the total amount of the printing formulation), and

DISPARLON 6700 (0.5 to 10% by weight, based on the total amount of the printing formulation).

(v)

α-Terpineol (70 to 90% by weight, based on the total amount of the printing formulation), Disperbyk 2022 (0.1 to 5% by weight, based on the total amount of the printing formulation), Ce³⁺:YAG (e.g. Tailorlux TL 0036®) (5 to 15% by weight, based on the total amount of the printing formulation),

ETHOCEL Std 4 Industrial (0.5 to 10% by weight, based on the total amount of the printing formulation), and

DISPARLON 6700 (0.5 to 10% by weight, based on the total amount of the printing formulation).

(vi)

Butylcarbitol (80 to 90 parts by weight),

Ethylcellulose (5 to 10 parts by weight),

Ce³⁺:YAG (e.g. Tailorlux TL 0036®) (5 to 15 parts by weight).

(vii)

Dipropylene glycol dimethyl ether (80 to 90 parts by weight),

Ethylcellulose (5 to 10 parts by weight),

Ce³⁺:YAG (e.g. Tailorlux TL 0036®) (5 to 15 parts by weight).

Solsperse 36000=polyamine dispersant

Ethocel=ethyl cellulose

Disparlon 6700=fatty acid diamide of ethylene diamine

Disperbyk 180=oligomeric MPEG-phosphate dispersant

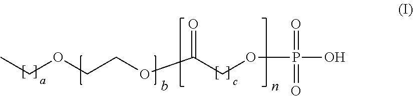

wherein a is 0 or an integer from 1 to 5, and b and c are independent of each other integers from 1 to 14, and n is 1 to 5.

Disperbyk 2022=acrylate copolymer dispersant

Amine value: 61 mg KOH/g

MW=9000 g/mol, PDI=1.6

Composition: by ¹H-NMR

| Monomers | Ratio (molar) |
|---|---|
| Benzylmethacrylate | 2 |
| Methylmethacrylate | 18 |
| Butylmethacrylate | 2.5 |
| Dimethylaminoethylmethacrylate | 9 |
| (DMAEMA) | |
| Ethylhexylmethacrylate (EHA) | 1 |

The lighting unit according to the present application may be used in any useful application for lighting units. Examples for useful applications are the use of a lighting unit according to the present invention in buildings, furniture, cars, trains, planes and ships. In specific, present invention is useful in all applications, in which illuminated glass is of benefit.

The lighting units according to the present application are for example used in facades, skylights, glass roofs, stair treads, glass bridges, canopies, railings, car windows and train windows.

The present invention therefore further relates to the use of the inventive lighting unit in buildings, furniture, cars, trains, planes and ships as well as to the use of the inventive lighting unit in facades, skylights, glass roofs, stair treads, glass bridges, canopies, railings, car glazing, train glazing.

The present invention further relates to the use of the inventive lighting unit for control of radiation, especially UV radiation (100-400 nm), visible radiation (400 nm to 700 nm) and infrared radiation (700 nm to 1 mm), i.e. near infrared (700 nm to 1400 nm), short wave length infrared (1.4 μm to 3 μm), mid length infrared (3 μm to 8 μm), long wave length infrared (8 μm to 15 μm) and far infrared (15 μm to 1000 μm), for optical control and/or for acoustical control.

The present invention further relates to the use of the inventive lighting unit in insulating glass units, windows, rotating windows, turn windows, tilt windows, top-hung windows, swinging windows, box windows, horizontal sliding windows, vertical sliding windows, quarterlights, store windows, skylights, light domes, doors, horizontal sliding doors in double-skin facades, closed cavity facades, all-glass constructions, D3-facades (Dual, Dynamic Durable Facade), facade glass construction elements (e.g. but not limited to fins, louvres), interactive facades (facades reacting on an external impulse e.g. but not limited to a motion control, a radio sensor, other sensors) curved glazing, formed glazing, 3D three-dimensional glazing, wood-glass combinations, over head glazing, roof glazing, bus stops, shower wall, indoor walls, indoor separating elements in open space offices and rooms, outdoor walls, stair treads, glass bridges, canopies, railings, aquaria, balconies, privacy glassand figured glass.

The present invention further relates to the use of the inventive lighting unit for thermal insulation, i.e. insulation against heat, insulation against cold, sound insulation, shading and/or sight protection. The present invention is preferably useful when combined with further glass layers to an insulation glass unit (IGU), which can be used for building facades. The IGU might have a double (Pane 1+Pane 2), or triple glazing (Pane 1+Pane 2+Pane 3), or more panes. The panes might have different thicknesses and different sizes. The panes might be of tempered glass, tempered safety glass, laminated glass, laminated tampered glass, safety glass. The lighting unit according to the present application may be used in any of the Panes 1, 2, 3. Materials can be put into the space between the panes. For example, but not limited such materials might be wooden objects, metal objects, expanded metal, prismatic objects, blinds, louvres, light guiding objects, light guiding films, light guiding blinds, 3-D light guiding objects, sun protecting blinds, movable blinds, roller blinds, roller blinds from films, translucent materials, capillary objects, honey comb objects, micro blinds, micro lamella, micro shade, micro mirrors insulation materials, aerogel, integrated vacuum insulation panels, holographic elements, integrated photovoltaics or combinations thereof.

The present invention further relates to the use of the inventive lighting unit in advertising panels, showcases, display facades, interactive facades, interactive bus stops, interactive train stations, interactive meeting points, interactive surfaces, motion sensors, light surfaces and background lighting, signage, pass protection. Optionally, a film and/or an imprinted film might be put on one or more surfaces.

The present invention further relates to the use of the inventive lighting unit in heat-mirror glazing, vacuum glazing, multiple glazing and laminated safety glass.

The present invention further relates to the use of the inventive lighting unit in transportation units, preferably in boats, in vessels, in spacecrafts, in aircrafts, in trains, in automotive, in trucks, in cars e.g. but not limited to windows, separating walls, light surfaces and background lighting, signage, pass protection, as sunroof, in the trunk lid, in the tailgate, for brake lights, for blinker, for position lights in said transportation units. Optional a film and/or an imprinted film might be put on one or more surfaces.

The present invention is preferentially useful when combined with further glass layers to an insulation glass unit (IGU), which can be used for building facades.

### EXAMPLES

The % values given in the examples are weight-% if nothing different is mentioned.

### Example 1

A lighting unit comprising the following elements:

A laminated safety glass comprised of:
A first sheet of float glass (2 mm thick, 30 cm×30 cm)
A functional interlayer comprised of
   A first PVB sheet (0.05 mm thick, 20 cm×30 cm) partially printed with luminous particles
   A second PVB sheet (0.76 mm),
A second sheet of float glass (2 mm thick, 30 cm×30 cm)

A single blue LED as light source with a peak emission wavelength of 450 nm attached to the face side of the laminated safety glass.

The luminous particles on the first PVB sheet comprise 2% organic luminophore OL1 (see below) and 98% PMMA (MW ˜12.000) and are evenly distributed in a regular pattern on the surface of a first PVB sheet.

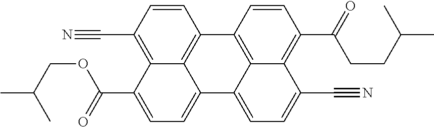 [SMILES: CC(C)CCC(=O)c1ccc2c3ccc(C#N)c4c(C(=O)OCC(C)C)ccc(c5ccc(C#N)c1c25)c43]

Organic luminophore OL1 used in example 1

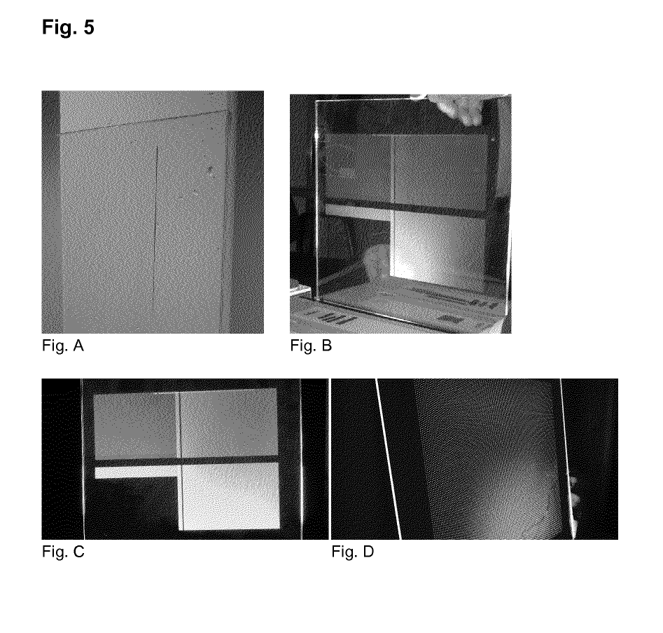

In the FIGS. A, B and C (see FIG. 5) the following is shown:

FIG. A: Laminated glass sheet with functionalized film after lamination in ambient light mode: printed structures not visible; overall transparency is >80%, determined as light transmission TL (380-780 nm) based on EN 410.

FIG. B: Laminated glass sheet with functionalized film and blue LED attached to edge and LED is switched on.

FIG. C: Laminated glass sheet with functionalized film and strip of 5 blue LEDs attached to edge and LEDs are switched on.

Preparation of the lighting unit according to example
i) A print formulation is prepared as follows:

20 ml benzyl alcohol is mixed with 1 g of PMMA (MW ˜12.000) and 20 mg of organic luminophore OL1. This mixture is placed onto a stirring plate and stirred for approximately 14 hours at room temperature. The resulting ink is filtered and used subsequently for ink-jet printing.
ii) The print formulation comprising the organic luminophore is printed onto the first PVB sheet as follows:

Test patterns are printed in 4 separated segments of the PVB foil. A cartridge inkjet printhead from Dimatix Fujifilm is used. The firing frequency is 10 kHz. Each segment has a different thickness of the luminous particles, which is achieved by repeated printing of individual segments (1 time, for upper left segment, 2 times for upper right segment, 4 times for lower left segment, 8 times for lower right corner). After printing, the PVB sheet is dried at ambient temperature by slowly evaporating the solvent. Coverage of the PVB foil with luminous particles is confirmed by UV lamp exposure.
iii) Preparation of laminated glass:

A first PVB sheet (0.05 mm thick, 20 cm×30 cm) partially printed with luminous particles is placed in a centered position onto a first glass sheet (2 mm thick, 30 cm×30 cm). A second PVB sheet (0.76 mm thick, >30 cm×30 cm) is then placed onto the first PVB sheet. A second glass sheet is then placed onto the second PVB sheet, coinciding with the first glass sheet. The fraction of the second PVB sheet protruding over the edge of the glass sheets is removed by cutting with a knife.

The stack of first glass sheet, first and second PVB sheet and second glass sheet was then prelaminated under vacuum (p=200 mBar) and elevated temperature (T=90° C.) for 30 min.

The final lamination was performed in an autoclave under elevated pressure (p=12 bar) and elevated temperature (T=140° C.) for 90 min.

FIG. A shows the laminated glass as described above without LED attached to it in ambient light condition. The transparency is >80%, determined as light transmission TL (380-780 nm) based on EN 410.
iv) Functional test with blue LED:

A blue LED light source (λₚₑₐₖ: 450 nm) was partially shielded so that only a strip of 4 mm width was illuminated and the glass laminate was placed onto the LED with the edge oriented towards the main beam direction. Figure X3 shows the laminated safety glass as described above with LED attached to it in dark environment. When the blue LED is switched on, greenish yellow light—as characteristic of organic luminophore OL1—is emitted by the laminated glass sheet perpendicular to its surface.

### Example 2

The lighting unit is identical with the lighting unit of example 1 with the only difference that instead of one single blue LED as light source a strip of 5 blue LEDs (λₚₑₐₖ: 450 nm) is attached to (λₚₑₐₖ: the side the glass laminate with the glass edge oriented towards the main beam direction.

i) Functional test with strip of blue LEDs:

FIG. C shows the laminated glass as described above with strip of 5 LEDs attached to it in dark environment and the LEDs being switched on. Greenish yellow light—as characteristic of organic luminophore OL1—is emitted by the laminated glass sheet perpendicular to its surface.

### Example 3

A lighting unit comprising the following elements:

A laminated safety glass comprised of:
A first sheet of float glass (4 mm thick, 50 cm×50 cm)
A functional interlayer comprised of
   A first ionoplast interlayer sheet (0.89 mm thick, 50 cm×50 cm) partially covered with luminous particles
A second sheet of float glass (4 mm thick, 50 cm×50 cm)

As light source, 5 blue LEDs with peak emission wavelength at 450 nm are evenly distributed on an aluminum profile with a length of 50 cm and attached to the face side of the laminated safety glass so that the blue light from the LED is directed into the glass laminate.

The luminous particles on the first ionoplast interlayer sheet comprise 50% cerium doped yttrium aluminum garnet (Y₃Al₅O₁₂: Ce³⁺) and 50% Ethylcellulose, and are evenly distributed in a regular pattern on the surface of a first ionoplast interlayer sheet, with a surface area coverage of 20%.

Preparation of the Lighting Unit According to Example 3
i) A print formulation was prepared as follows: 80 g of butylcarbitol is mixed with 10 g of Ehylcellulose and 10 g of Ce³⁺:YAG (e.g. Tailorlux TL0036®). This mixture is dispersed for 4 hrs.
ii) The print formulation comprising the organic luminophore is printed onto the first ionoplast interlayer sheet as follows:

An homogeneous test pattern comprising single luminous particles with 1 mm diameter and an average area coverage of 10% is screen-printed on the ionoplast interlayer sheet using a polyester printing screen. After printing, the ionoplast interlayer sheet is dried for 8 min in a tunnel furnace at maximum temperature of 50° C. by evaporating the solvent. Coverage of the ionoplast interlayer sheet with luminous particles is confirmed by UV lamp exposure.

iii) Preparation of laminated glass:

The first ionoplast interlayer sheet (0.89 mm thick, 50 cm×50 cm) covered with printed luminous particle pattern is placed in a centered position onto a first glass sheet (4 mm thick, 50 cm×50 cm). A second glass sheet is then placed onto the ionoplast interlayer sheet, coinciding with the first glass sheet and the ionoplast interlayer sheet.

The stack of first glass sheet, first ionoplast interlayer sheet and second glass sheet is then placed in a vacuum bag (p=200 mBar) and the vacuum bag is then placed in an autoclave under elevated pressure (p=12 bar) and elevated temperature (T=140° C.) for 90 min.

The transparency, determined as light transmission TL (380-780 nm) based on EN 410, of the resulting laminated glass is larger than 80% over the whole area.

iv) Functional test with blue LED:

A strip light source of 5 blue LEDs (λₚₑₐₖ: 450 nm) is attached to the side the laminated glass sheet with the sheet's edge oriented towards the main beam direction. Figure D shows the laminated safety glass as described above with the strip of 5 LEDs attached to it in dark environment and the LEDs being switched on. White light is emitted by the laminated glass sheet perpendicular to its surface (blue light observed in image is light reflected by the wall behind the laminated glass sheet). Luminous particle pattern can be observed.

In FIG. D (see FIG. 5) the following is shown:

FIG. D: Laminated glass sheet with functionalized film and strip of 5 blue LEDs attached to edge and switched on.

1. A lighting unit in form of laminated layers comprising
a) a layer (A);
b) a layer (B);
wherein at least one of the layers (A) or (B) is optically transparent, and the layers (A) and (B) are arranged parallel to each other,
c) at least one functional interlayer (C), arranged between the layers (A) and (B) and arranged parallel to the layers (A) and (B);
d) at least one light source (D), arranged at an edge of the laminated layers,
wherein the functional interlayer (C) comprises luminous particles.

2. The lighting unit according to claim 1, wherein the layers (A) and (B) are based on glass or transparent polymers, preferably glass, more preferably low-iron glass, or preferably PVC (polyvinylchloride), PMMA (polymethyl methacrylate), PC (polycarbonate), PS (polystyrene), PPO (polypropylene oxide), PE (polyethylene), PEN (polyethylene naphthalate), PP (polypropylene), PET (polypropylene terephthalate), PES (polyether sulfones), PI (polyimides) and mixtures thereof.

3. The lighting unit according to claim 1 or 2, wherein the interlayer (C) is based on an ionomer (ionoplast), acid copolymers of α-olefins and α,β-ethylenically unsaturated carboxylic acids, ethylene vinyl acetate (EVA), polyvinyl acetal (for example poly(vinylbutyral)) (PVB), including acoustic grades of poly(vinyl acetal), thermoplastic polyurethane (TPU), polyvinyl chloride (PVC), polyethylenes (for example metallocene-catalyzed linear low density polyethylenes), polyolefin block elastomers, ethylene acrylate ester copolymers (for example poly(ethylene-co-methyl-acrylate) and poly(ethylene-co-butyl acrylate)), silicone elastomers, epoxy resins and mixtures thereof.

4. The lighting unit according to any one of claims 1 to 3, wherein the luminous particles comprise:
i) at least one matrix (i), and
one or both of the following components (ii) and (iii):
ii) at least one luminophore (ii);
iii) at least one grit (iii).

5. The lighting unit according to claim 4, wherein the matrix (i) comprises homo- or copolymers of: (meth)acrylates, i.e. polymethacrylates or polyacrylates, for example polymethyl(meth)acrylate, polyethyl(meth)acrylate or polyisobutyl(meth)acrylate; poly(vinyl acetal), especially poly(vinyl butyrate) (PVB), cellulose polymers like ethyl cellulose, nitro cellulose, hydroxy alkyl cellulose, poly(vinyl acetate), polystyrenes (PS), thermoplastic polyurethane (TPU), polyimides, polyethylene oxides, polypropylene oxides, polyamines, polycaprolactones, phosphoric acid functionalized polyethylene glycols, polyethylene imines, polycarbonates (PC), polyethylene terephthalate (PET), ethylene vinyl acetate (EVA), polyethylenes (for example metallocene-catalyzed linear low density polyethylenes), castor oil, polyvinylpyrrolidone, polyvinyl chloride, polybutene, silicone, epoxy resin, polyvinyl alcohol, polyacrylonitrile, polyvinylidene chloride (PVDC), polystyreneacrylonitrile (SAN), polybutylene terephthalate (PBT), polyvinyl butyrate (PVB), polyvinyl chloride (PVC), polyamides, polyoxymethylenes, polyimides, polyetherimide or mixtures thereof.

6. The lighting unit according to claim 4 or 5, wherein the luminophore (ii) comprises inorganic luminescent colorants and/or organic luminescent colorants, wherein preferred inorganic luminescent colorants are silicate-based phosphors of a general composition A₃Si(O,D)₅ or A₂Si(O,D)₄, in which Si is silicone, O is oxygen, A comprises strontium (Sr), bariu (Ba), magnesium (Mg) or calcium (Ca) and D comprises chlorine (Cl), fluorine (F), nitrogen (N) or sulfur, aluminum-based phosphors, aluminum-silicate-based phosphors, nitride-based phosphors, sulfate phosphors, oxy-nitride phosphors, oxy-sulfate phosphors, garnet materials, iron oxides, titanium dioxide, lead chromate pigments, lead molybdate pigments, nickel titanium pigments or chromium oxide or mixtures thereof, and preferred organic luminescent colorants are organic luminescent pigments or organic luminescent dyes, for example functionalized naphthalene derivatives or functionalized rylene derivatives, for example naphthalene comprising compounds bearing one or more substituents selected from halogen, cyano, benzimidazole or one or more groups bearing carbonyl functions or perylene compounds bearing one or more substituents selected from halogen, cyano, benzimidazole, or one or more groups bearing carbonyl functions, heterocyclic hydrocarbons, cumarins, stilbenes, cyanines, rubrens, pyranines, rhodanines, phenoxazines, diazo compounds, isoindoline derivatives, monoazo compounds, anthrachinone pigments, thioindigo derivatives, azomethine derivatives, chinacridones, perinones, dioxazines, pyrazolo-chinazolones, polycyclic compounds comprising keto groups, phthalocyanines, varnished basic colorants, benzoxanthene or benzimidazoxanthenoisoquinolinone or mixtures thereof, or inorganic quantum dots, especially based on CdSe, CdTe, ZnS, InP, PbS, CdS or mixtures thereof.

7. The lighting unit according to any one of claims 4 to 6, wherein the grit (iii) is selected from particles comprising TiO₂, SnO₂, ZnO, Al₂O₃, Y₃Al₅O₁₂, barium sulfate, lithopone, zinc sulfide, calcium carbonate, ZrO₂ and mixtures thereof.

8. The lighting unit according to any one of claims 4 to 7, wherein the luminous particles comprise ethyl cellulose, nitro cellulose, hydroxyalkyl cellulose or poly(meth)acrylate or copolymers comprising (meth)acrylate or mixtures thereof as at least one matrix (i), and one or both of the following components (ii) and (iii): cerium doped yttrium aluminum garnet, or mixtures thereof as at least one luminophore (ii), TiO₂ , Al₂O₃ or Y₃Al₅O₁₂ as at least one grit (iii).

9. The lighting unit according to any one of claims 4 to 8, wherein the luminous particles comprise:
In the case of organic luminophores (ii):
i) 45% by weight to 99.99% by weight, 77% by weight to 99.93% by weight, more preferably 93.5% to 99.85% by weight of at least one matrix (i),
ii) 0.01 to 5% by weight, preferably 0.02 to 3% by weight, more preferably 0.05 to 2.5% by weight of at least one organic luminophore (ii),
iii) 0 to 50% by weight; preferably 0.05 to 20% by weight; more preferably 0.1 to 4% by weight of at least one grit (iii);
wherein the sum of all components (i), (ii) and (iii) is 100% by weight;
in the case of in organic luminophores (ii):
i) 15% by weight to 99.5% by weight, 30% by weight to 97.5% by weight, more preferably 38% to 97% by weight of at least one matrix (i),
ii) 0 to 60% by weight, preferably 1 to 55% by weight, more preferably 2 to 52% by weight of at least one inorganic luminophore (ii),
iii) 0 to 60% by weight, preferably 1 to 55% by weight, more preferably 2 to 52% by weight of at least one grit (iii);
wherein the sum of all components (i), (ii) and (iii) is 100% by weight.

10. The lighting unit according to any one of claims 1 to 9, comprising:
a) a layer (A);
b) a layer (B);
wherein at least one of the layers (A) or (B) is optically transparent, and the layers (A) and (B) are arranged parallel to each other,
c) at least one functional interlayer (C), arranged between the layers (A) and (B) and arranged parallel to the layers (A) and (B);
c′) at least one interlayer (C′), arranged between the layers (C) and (B) and arranged parallel to the layers (C) and (B) and/or arranged between the layers (A) and (C) and arranged parallel to the layers (A) and (C);
d) at least one light source (D), arranged at an edge of the laminated layers,
wherein the functional interlayer (C) comprises luminous particles.

11. The lighting unit according to any one of claims 1 to 10, wherein the light source (D) is selected from LED, OLED, laser and gas-discharge lamps, preferably from LED and OLED, most preferably from LED.

12. The lighting unit according to any one of claims 1 to 11, wherein the luminous particles are applied to the interlayer (C) by printing, most preferably by inkjet printing or by screen printing.

13. Process for preparing a lighting unit according to any one of claims 1 to 12 comprising the steps of
i) applying luminous particles to a layer (C*), whereby the functional interlayer (C) is formed;
ii) laminating a layer (A) at least one functional interlayer (C) and a layer (B), wherein the layers (A), (C) and (B) are arranged parallel to each other, whereby the at least one layer (C) is arranged between layers (A) and (B);
iii) mounting the at least one light source (D) at an edge of the laminated layer.

14. A process according to claim 13, wherein the luminous particles are applied to the layer (C*) by printing, preferably by screen printing or inkjet printing.

15. Use of a lighting unit according to any one of claims 1 to 12 in buildings, furniture, cars, trains, planes and ships as well as in facades, skylights, glass roofs, stair treads, glass bridges, canopies, railings, car glazing, train glazing.

16. Use of a lighting unit according to any one of claims 1 to 12 for control of radiation, for optical control and/or acoustical control.

17. Use of the lighting unit according to any one of claims 1 to 12 ininsulating glass units, windows, rotating windows, turn windows, tilt windows, top-hung windows, swinging windows, box windows, horizontal sliding windows, vertical sliding windows, quarterlights, store windows, skylights, light domes, doors, horizontal sliding doors in double-skin facades, closed cavity facades, all-glass constructions, D3-facades, facade glass construction elements, interactive facades, curved glazing, formed glazing, 3D three-dimensional glazing, wood-glass combinations, over head glazing, roof glazing, bus stops, shower wall, indoor walls, indoor separating elements in open space offices and rooms, outdoor walls, stair treads, glass bridges, canopies, railings, aquaria, balconies, privacy glass and figured glass.

18. Use of a lighting unit according to any one of claims 1 to 12 for thermal insulation, sound insulation, shading and/or sight protection.

19. Use of the lighting unit according to any one of claims 1 to 12 in advertising panels, showcases, display facades, interactive facades, interactive bus stops, interactive train stations, interactive meeting points, interactive surfaces, motion sensors, light surfaces and background lighting, signage, pass protection.

20. Use of the inventive lighting unit according to any one of claims 1 to 12 in transportation units, preferably in boats, in vessels, in spacecrafts, in aircrafts, in trains, in automotive, in trucks, in cars, more preferably in windows, separating walls, light surfaces, background lighting, signage, pass protection, as sunroof, in the trunk lid, in the tailgate, for brake lights, for blinker, for position lights in said transportation units.

21. Use of a lighting unit according to any one of claims 1 to 12 in heat-mirror glazing, vacuum glazing and laminated safety glass.

22. Facades, skylights, glass roofs, stair treads, glass bridges, canopies, railings, car windows, train windows, furniture, planes, ships, advertising panels, show cases, motion sensors, bus stops, light domes, shower screens, interior walls, aquaria, balconies, windows, doors and laminated safety glass comprising the lighting unit according to any one of claims 1 to 12.
